(19) United States
(12) Patent Application Publication
(10) Pub. No.: US 2015/0379630 A1
(43) Pub. Date: Dec. 31, 2015

(54) METHOD AND SYSTEM FOR GENERATING DATA PACKET WITH SERIAL NUMBER

(71) Applicant: SHENZHEN CIFPAY NETWORK BANK TECHNOLOGY CO., LTD., Futian Shenzhen (CN)

(72) Inventor: Yi Zhang, Futian Shenzhen (CN)

(73) Assignee: SHENZHEN CIFPAY NETWORK BANK TECHNOLOGY CO., LTD, Futian Shenzhen (CN)

(21) Appl. No.: 14/421,868

(22) PCT Filed: Mar. 18, 2013
(86) PCT No.: PCT/CN2013/072791

§ 371 Date: Feb. 16, 2015

(51) Int. Cl. G06Q 40/02; G06Q 20/40; H04L 29/06

(52) U.S. Cl. CPC G06Q 40/02; H04L 69/22; G06Q 20/405

(57) ABSTRACT

The present disclosure provides a method and a system for generating a data packet with a serial number, the method includes: receiving a data packet with application messages; generating a payment promise information data packet, and returning a serial number applying message to a network terminal; and generating serial number information by the network terminal. The solution of the disclosure realizes a promised paying information data packet with a user-defined serial number of a user characteristic and application scenario, thus facilitating the visual recognition of a user.

### FIELD OF THE INVENTION

The present disclosure relates to a field of electronic commerce, and more particularly relates to a method and a system for generating a data packet with a serial number.

### BACKGROUND OF THE INVENTION

Electronic commerce has been more and more widely used in all kinds of commercial trade activities. The so-called electronic commerce refers to a commercial operation model based on browser and server application strategies in an Internet opened network environment. This kind of commercial operation model implements online shopping of consumers, online trading between merchants, online electronic payments, various commercial activities, trading activities and finance activities, and related comprehensive services.

However, a data packet for interchanging is generally represented in a form of swift number, which is difficult for a user to identify.

### SUMMARY OF THE INVENTION

Embodiments of the disclosure provide a method and a system for generating a data packet with a serial number, and facilitate the visual recognition of a user.

A method for generating a data packet with a serial number includes:

receiving a data packet with application messages;

generating a payment promise information data packet, and returning a serial number applying message to a network terminal; and

generating serial number information by the network terminal.

Preferably, the data packet with application messages includes a payment instruction, a paying bank, and a payment amount.

Preferably, the serial number information includes a name of a paying bank and/or a name of the data packet and/or a payment amount and/or payer information.

Preferably, the payment promise information data packet includes the serial number information, a payment amount, a payment currency, a paying account, status information, an issue date, and a valid date.

Preferably, the method further includes;

receiving a paying account name and a password for the paying account;

determining whether the paying account name and the password for the paying account are correct; and

proceeding to a next determination or returning the serial number applying message to the network terminal if the paying account name and the password for the paying account are correct

Preferably, the method further includes:

determining whether a fund of the paying account is greater than a payment amount in the data packet with application messages;

returning the serial number applying message to the network terminal if the fond of the paying account is no less than the payment amount of the data packet with application messages.

Another purpose of the disclosure is to provide a system for generating a data packet with a serial number, the system includes a network terminal and a bank server:

the bank server is connected to the network terminal, and is configured to receive a data packet with application messages, to generate a payment promise information data packet, and to return a serial number applying message to the network terminal.

the network terminal is configured to generate serial number information.

Preferably, the bank server is further configured to receive a paying account name and a password for the paying account, and is configured to determine whether the paying account name and the password for the paying account are correct, and proceed to a next determination or returning the serial number applying message to the network terminal if the paying account name and the password for the paying account are correct.

Preferably, the bank server is further configured to determine whether a fund of the paying account is greater than a payment amount in the data packet with application messages, and return the serial number applying message to the network terminal if the fund of the paying account is no less than the payment amount of the data packet with application messages.

Preferably, the network terminal further includes a payment gateway;

the payment gateway is configured to transform data sent by the network terminal to the bank server into appropriate data for the bank server, and transform data sent by the bank server to the network terminal into appropriate data for the network terminal. The embodiments mentioned above implement a promised paying information data packet with a user-defined serial number of a user characteristic and application scenario, thus facilitating the visual recognition of a user.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG 1 is a flow chart of a method for generating a data packet with a serial number in accordance with an embodiment;

FIG. 2 is a flow chart of a method for generating a data packet with a serial number in accordance with another embodiment; and

FIG. 3 is a block diagram of a system for generating a data packet with a serial number in accordance with an embodiment.

### DETAILED DESCRIPTION OF THE EMBODIMENTS

Embodiments of the invention are described more fully hereinafter with reference to the accompanying drawings.

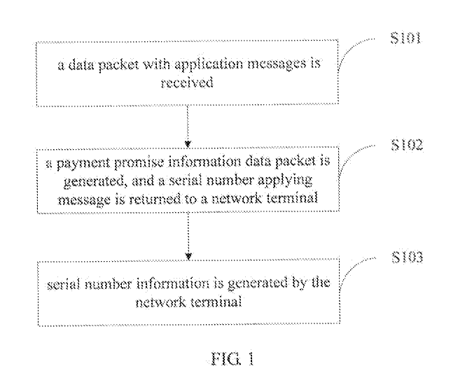

Referring to FIG. 1, FIG. 1 shows a flow chart of a method for generating a data packet with a serial number in accordance with an embodiment, the method includes:

In step S101, a data packet with application messages is received.

Specifically, the data packet with application messages includes a payment instruction, a paying bank, and a payment amount.

In step S102, a payment promise information data packet is generated, and a serial number applying message is returned to a network terminal.

Specifically, the payment promise information data packet includes the serial number information, a payment amount, a payment currency, a paying account, status information, an issue date, and a valid date; the serial number applying message is returned by a bank server to a network terminal.

In step S103, serial number information is generated by the network terminal.

Specifically, the serial number information includes a name of a paying bank and/or a name of the data packet and/or a payment amount and/or payer information. The embodiments mentioned above implement a promised paying information data packet with a user-defined serial number of a user characteristic and application scenario, thus facilitating the visual recognition of a user.

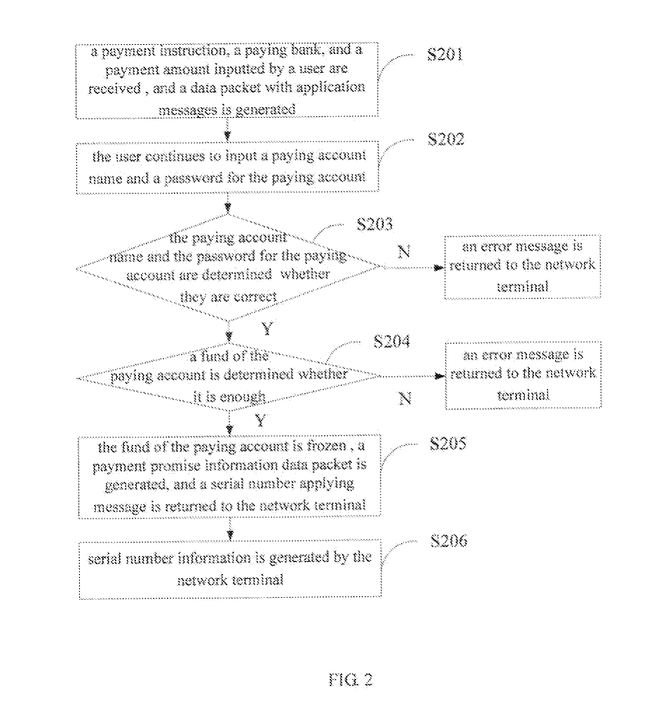

FIG. 2 shows a flow chart of a method for generating a data packet with a serial number in accordance with another embodiment, the method includes:

In step S201, a payment instruction, a paying bank, and a payment amount inputted by a user are received by a network terminal and a data packet with application messages is generated.

In step S202, after the data packet with application messages is received by a bank server, the user continues to input a paying account name and a password for the paying account on the bank server.

In step S203, the bank server determines whether the paying account name and the password for the paying account are correct. If the paying account name and the password for the paying account are correct, the method proceeds to step S204. If the paying account name or the password for the paying account is incorrect, an error message is returned to the network terminal.

In step S204, the bank server determines whether a fund of the paying account is greater than a payment amount of the data packet with application messages. If the fund of the paying account is no less than the payment amount of the data packet with application messages, the method proceeds to step S205. If the fund of the paying account is less than the payment amount of the data packet with application messages, an error message is returned to the network terminal.

Specifically, the order of step S203 and step S204 can be exchanged.

In step S205, the fund of the paying account is frozen by a bank server terminal, a payment promise information data packet is generated, and a serial number applying message is returned to the network terminal.

Specifically, the payment promise information data packet comprises the serial number information, a payment amount, a payment currency, a paying account, status information, an issue date, and a valid date.

In step S206, the network terminal receives the serial number applying message, and then generates serial number information.

Specifically, the serial number information can be in a form of “name of a paying bank*payment currency*payer information”, separating by delimiters in the middle, or in a form of free combination of the above information, such as: name of a paying bank*payment currency, name of a paying bank*payer information, and so on. The serial number information shows various information of the data packet, thus facilitating the visual recognition of a user.

All the interacting steps between the network terminal and the bank server mentioned above can be implemented through a payment gateway, which is configured to transform the data sent by the network terminal to the bank server into appropriate data for the bank server, and transform the data sent by the bank server to the network terminal into appropriate data for the network terminal.

The embodiments mentioned above implement a promised paying information data packet with a user-defined serial number of a user characteristic and application scenario, and facilitates the visual recognition of a user.

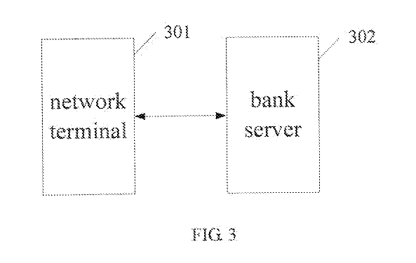

FIG. 3 shows a block diagram of a system for generating a data packet with a serial number in accordance with an embodiment, the system for generating a data packet with a serial number will be explained in detail in company with FIG 3.

A bank server 302 is connected to a network terminal 301, and is configured to receive a data packet with application messages, to generate a payment promise information data packet, and to return a serial number applying message to the network terminal 301.

The network terminal 301 is configured to generate serial number information.

Specifically, the bank server 302 is further configured to receive a paying account name and a password for the paying account, determine whether the paying account name and the password for the paying account are correct, and proceed to a next determination if the paying account name and the password for the paying account are correct, or return the serial number applying message to the network terminal 301.

Specifically, the bank server 302 is further configured to determine whether a fund of the paying account is greater than a payment amount of the data packet with application messages, and return the serial number applying message to the network terminal 301 if the fund of the paying account is no less than the payment amount of the data packet with application messages.

Specifically, the network terminal 301 further includes a payment gateway. The payment gateway is configured to transform the data sent by the network terminal 301 to the bank server 302 into appropriate data for the bank server 302, and transform the data sent by the bank server 302 to the network terminal 301 into appropriate data for the network terminal 301.

The embodiments mentioned above implement a promised paying information data packet with a user-defined serial number of a user characteristic and application scenario, thus facilitating the visual recognition of a user.

Embodiments of the invention may he implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical optical, acoustical or other forms of propagated signals (e.g., carrier waves, infrared signals, digital signals, etc.), and others.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method for generating a data packet with a serial number, comprising: receiving a data packet with application messages;
generating a payment promise information data packet, and returning a serial number
applying message to a network terminal; and
generating serial number information by the network terminal.

2. The method according to claim L wherein the data packet with application messages comprises a payment instruction, a paying bank, and a payment amount.

3. The method according to claim 1, wherein the serial number information comprises a name of a paying bank and/or a name of the data packet and/or a payment amount and/or payer information.

4. The method according to claim 1, wherein the payment promise information data packet comprises the serial number information, a payment amount, a payment currency, a paying account, status information, an issue date, and a valid date.

5. The method according to claim 1, further comprising:
receiving a paying account name and a password for the paying account; determining whether the paying account name and the password for the paying account are correct: and
proceeding to a next determination or returning the serial number applying message to the network terminal if the paying account name and the password for the paying account are correct.

6. The method according to claim 5, further comprising:
determining whether a fund of the paying account is greater than a payment amount in the data packet with application messages;
returning the serial number applying message to the network terminal if the fund of the paying account is no less than the payment amount of the data packet with application messages.

7. A system for generating a data packet with a serial number, comprising a network terminal and a bank server;
wherein the bank server is connected to the network terminal, and is configured to receive a data packet with application messages, to generate a payment promise information data packet, and to return a serial number applying message to the network terminal;
the network terminal is configured to generate serial number information.

8. The system according to claim 7, wherein
the bank server is further configured to receive a paying account name and a password for the paying account, and is configured to determine whether the paying account name and the password for the paying account are correct, and proceed to a next determination or returning the serial number applying message to the network terminal if the paying account name and the password for the paying account arc correct.

9. The system according to claim 8, wherein
the bank server is further configured to determine whether a fund of the paying account is greater than a payment amount in the data packet with application messages, and return the serial number applying message to the network terminal if the fund of the paying account is no less than the payment amount of the data packet with application messages.

10. The system according to claim 7, wherein the network terminal further comprises a payment gateway, the payment gateways is configured to transform data sent by the network terminal to the bank server into appropriate data for the bank server, and transform data sent by the bank server to the network terminal into appropriate data for the network terminal.
